(19) United States
(12) Patent Application Publication
(10) Pub. No.: US 2024/0354628 A1
(43) Pub. Date: Oct. 24, 2024

(54) SOLVING OPTIMIZATION PROBLEM ON HYBRID QUANTUM-CLASSICAL COMPUTING SYSTEM

(71) Applicant: IONQ, INC., College Park, MD (US)

(72) Inventor: Ananth Prakash KAUSHIK, Santa Clara, CA (US)

(21) Appl. No.: 18/378,938

(22) Filed: Oct. 11, 2023

Related U.S. Application Data
(60) Provisional application No. 63/421,258, filed on Nov. 1, 2022.

(51) Int. Cl. G06N 10/60; G06N 10/40

(52) U.S. Cl. CPC G06N 10/60; G06N 10/40

(57) ABSTRACT

A method of performing computation in a hybrid quantum-classical computing system includes mapping an optimization problem to a model Hamiltonian, selecting a set of variational parameters to construct a parametrized quantum circuit comprising an entangling circuit based on the model Hamiltonian and a mixing circuit, setting a quantum processor in an initial state, executing iterations, each iteration including applying the parametrized quantum circuit to the quantum processor to generate a trial state, measuring an expectation value of the model Hamiltonian, and replacing the set of the variational parameters with another set of variational parameters, and outputting the set of the variational parameters. The initial and trial states each are a superposition of states where the number qubits in the 1 state is constant, and the mixing circuit maintains the number of the qubits in the 1 state.

### CROSS-REFERENCE TO RELATED APPLICATIONS

This application claims priority to U.S. Provisional Application Ser. No. 63/421,258 filed Nov. 1, 2022, which is herein incorporated by reference in its entirety.

### BACKGROUND

### Field

The present disclosure generally relates to a method of performing computation in a hybrid quantum-classical computing system, and more specifically, to a method of solving an optimization problem in a hybrid computing system that includes a classical computer and a quantum computer that includes trapped ions.

### Description of the Related Art

In current state-of-the-art quantum computers, control of qubits is imperfect (noisy) and the number of qubits used in these quantum computers generally range from a hundred qubits to thousands of qubits. The number of quantum gates that can be used in such a quantum computer (referred to as a “noisy intermediate-scale quantum device” or “NISQ device”) to construct circuits to run an algorithm within a controlled error rate is limited due to the noise.

For solving some optimization problems, a NISQ device having shallow circuits (with small number of gate operations to be executed in time-sequence) can be used in combination with a classical computer (referred to as a hybrid quantum-classical computing system). For example, a classical computer (also referred to as a “classical optimizer”) instructs a controller to execute quantum gate operations on a NISQ device (also referred to as a “quantum processor”) and measure an outcome of the quantum processor. Subsequently, the classical optimizer instructs the controller to prepare the quantum processor in a slightly different state, and repeats execution of the gate operation and measurement of the outcome. This cycle is repeated until the approximate solution can be extracted. Such hybrid quantum-classical computing system having an NISQ device may outperform classical computers in finding approximate solutions to such optimization problems. However, this iterative process may not converge to find solutions due to inappropriate selection of an initial state at the beginning of the iterative process.

Therefore, there is a need for improved methods for solving optimization problems on a hybrid quantum-classical computing system.

### SUMMARY

Embodiments of the present disclosure provide a method of performing computation in a hybrid quantum-classical computing system comprising a classical computer and a quantum processor. The method includes mapping, by a classical computer, an objective function of an optimization problem to a model Hamiltonian, selecting, by the classical computer, a set of variational parameters to construct a parametrized quantum circuit comprising an entangling circuit based on the model Hamiltonian and a mixing circuit, setting, by a system controller, a quantum processor in an initial state, wherein the quantum processor comprises a plurality of trapped ions, each of which has two hyperfine states defining a qubit, executing iterations, each iteration including applying, by the system controller, the parametrized quantum circuit to the quantum processor based on the set of the variational parameters and the model Hamiltonian, to transform the quantum processor to a trial state, measuring, by the system controller, an expectation value of the model Hamiltonian, and replacing, by the classical computer, the set of the variational parameters with another set of variational parameters, if a difference between the measured expectation value of the model Hamiltonian and the expectation value of the model Hamiltonian measured in the previous iteration is more than a predetermined value, and outputting the set of the variational parameters. The initial state and the trial state each are a superposition of states where the number of trapped ions of the plurality of trapped ions in the hyperfine excited state is constant, and the mixing circuit maintains the number of the trapped ions in the hyperfine excited state.

Embodiments of the present disclosure also provide a hybrid quantum-classical computing system. The hybrid quantum-classical computing system includes a quantum processor comprising a plurality of trapped ions, each of the trapped ions having two hyperfine states defining a qubit, one or more lasers configured to emit a laser beam, which is provided to trapped ions in the quantum processor, and a classical computer configured to map an objective function of an optimization problem to a model Hamiltonian, select a set of variational parameters to construct a parametrized quantum circuit comprising an entangling circuit based on the model Hamiltonian and a mixing circuit, control a system controller to the quantum processor in an initial state, execute iterations, each iteration comprising controlling the system controller to apply the parametrized quantum circuit to the quantum processor based on the set of the variational parameters and the model Hamiltonian, to transform the quantum processor to a trial state, controlling by the system controller to measure an expectation value of the model Hamiltonian, and replacing the set of the variational parameters with another set of variational parameters, if a difference between the measured expectation value of the model Hamiltonian and the expectation value of the model Hamiltonian measured in the previous iteration is more than a predetermined value, and output the set of the variational parameters. The initial state and the trial state each are a superposition of states where the number of trapped ions of the plurality of trapped ions in the hyperfine excited state is constant, and the mixing circuit maintains the number of the trapped ions in the hyperfine excited state.

Embodiments of the present disclosure further provide a hybrid quantum-classical computing system comprising non-volatile memory having a number of instructions stored therein. The number of instructions which, when executed by one or more processors, causes the hybrid quantum-classical computing system to perform operations comprising mapping, by a classical computer, an objective function of an optimization problem to a model Hamiltonian, selecting, by the classical computer, a set of variational parameters to construct a parametrized quantum circuit comprising an entangling circuit based on the model Hamiltonian and a mixing circuit, setting, by a system controller, a quantum processor in an initial state, wherein the quantum processor comprises a plurality of trapped ions, each of which has two hyperfine states defining a qubit, executing iterations, each iteration comprising applying, by the system controller, the parametrized quantum circuit to the quantum processor based on the set of the variational parameters and the model Hamiltonian, to transform the quantum processor to a trial state, measuring, by the system controller, an expectation value of the model Hamiltonian, and replacing, by the classical computer, the set of the variational parameters with another set of variational parameters, if a difference between the measured expectation value of the model Hamiltonian and the expectation value of the model Hamiltonian measured in the previous iteration is more than a predetermined value, and outputting the set of the variational parameters. The initial state and the trial state each are a superposition of states where the number of trapped ions of the plurality of trapped ions in the hyperfine excited state is constant, and the mixing circuit maintains the number of the trapped ions in the hyperfine excited state.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a schematic partial view of an ion trap quantum computing system according to one embodiment.

FIG. 2A depicts a schematic energy diagram of each ion in an ion chain according to one embodiment.

FIG. 2B depicts a schematic motional sideband spectrum of an ion in an ion chain according to one embodiment.

FIG. 3 depicts a flowchart illustrating a method of obtaining a solution to an optimization problem by Quantum Approximate Optimization Algorithm (QAOA) according to one embodiment.

FIG. 4A illustrates a mixing circuit according to one embodiment.

FIG. 4B illustrates Givens rotation gates according to one embodiment.

To facilitate understanding, identical reference numerals have been used, where possible, to designate identical elements that are common to the figures. In the figures and the following description, an orthogonal coordinate system including an X-axis, a Y-axis, and a Z-axis is used. The directions represented by the arrows in the drawing are assumed to be positive directions for convenience. It is contemplated that elements disclosed in some embodiments may be beneficially utilized on other implementations without specific recitation.

### DETAILED DESCRIPTION

Embodiments described herein are generally related to a method and a system for performing a computation using a hybrid quantum-classical computing system, and, more specifically, to providing an approximate solution to an optimization problem using a hybrid quantum-classical computing system that includes an ion chain including trapped ions.

In the embodiments described herein, a method for obtaining a solution to an optimization problem on a hybrid quantum-classical computing system is provided, using the travelling salesman problem (TSP) as an example of an optimization problem. The TSP is mapped onto a one-dimensional (1D) Hubbard model and constraints of the TSP are dealt with the Coulomb repulsion terms and a fixed number of electrons in the Hubbard model. The initial state of a variational search to solve the problem is chosen to span a large portion of a solution space, and thus the variational search likely converges.

### General Hardware Configurations

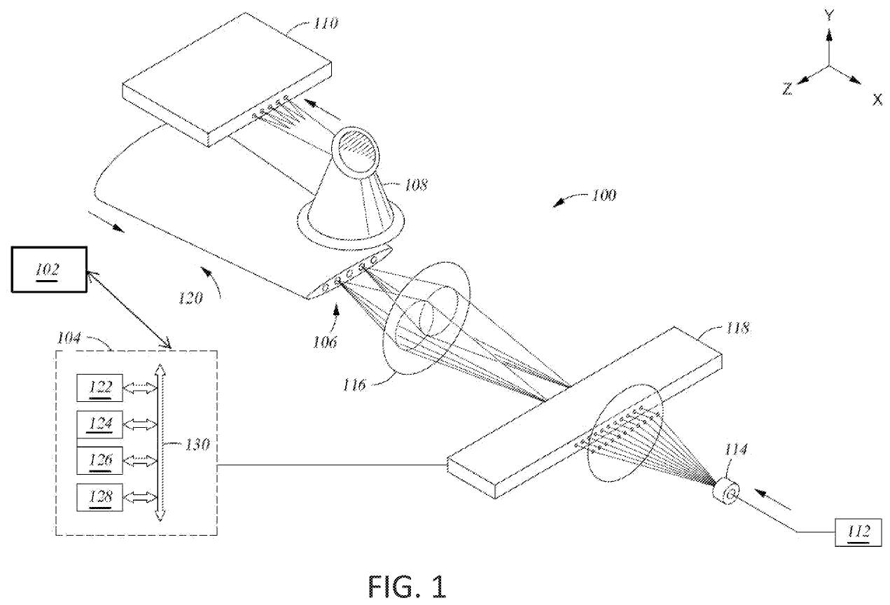

FIG. 1 is a schematic partial view of an ion trap quantum computing system, or system 100, according to one embodiment. The system 100 includes a classical (digital) computer 102, a system controller 104 and a quantum processor that is an ion chain 106 having trapped ions (i.e., five shown) that extend along the Z-axis. The classical computer 102 includes a central processing unit (CPU), memory, and support circuits (or I/O). The memory is connected to the CPU, and may be one or more of a readily available memory, such as a read-only memory (ROM), a random access memory (RAM), floppy disk, hard disk, or any other form of digital storage, local or remote. Software instructions, algorithms and data can be coded and stored within the non-volatile memory for instructing the CPU. The support circuits (not shown) are also connected to the CPU for supporting the processor in a conventional manner. The support circuits may include conventional cache, power supplies, clock circuits, input/output circuitry, subsystems, and the like.

An imaging objective 108, such as an objective lens with a numerical aperture (NA), for example, of 0.37, collects fluorescence along the Y-axis from the ions and maps each ion onto a multi-channel photo-multiplier tube (PMT) 110 for measurement of individual ions. Non-copropagating Raman laser beams from a laser 112, which are provided along the X-axis, perform operations on the ions. A diffractive beam splitter 114 creates an array of static Raman beams 116 that are individually switched using a multi-channel acousto-optic modulator (AOM) 118 and is configured to selectively act on individual ions. A global Raman laser beam 120 illuminates all ions at once. The system controller (also referred to as a “RF controller”) 104 controls the AOM 118 and thus controls laser pulses to be applied to trapped ions in the ion chain 106. The system controller 104 includes a central processing unit (CPU) 122, a read-only memory (ROM) 124, a random access memory (RAM) 126, a storage unit 128, and the like. The CPU 122 is a processor of the system controller 104. The ROM 124 stores various programs and the RAM 126 is the working memory for various programs and data. The storage unit 128 includes a nonvolatile memory, such as a hard disk drive (HDD) or a flash memory, and stores various programs even if power is turned off. The CPU 122, the ROM 124, the RAM 126, and the storage unit 128 are interconnected via a bus 130. The system controller 104 executes a control program which is stored in the ROM 124 or the storage unit 128 and uses the RAM 126 as a working area. The control program will include software applications that include program code that may be executed by processor in order to perform various functionalities associated with receiving and analyzing data and controlling any and all aspects of the methods and hardware used to create the ion trap quantum computer system 100 discussed herein.

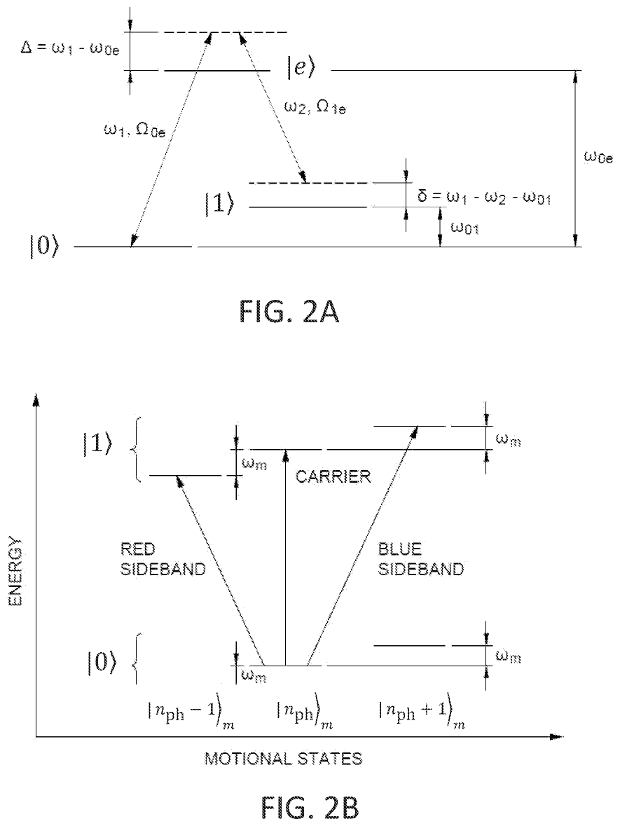

FIG. 2A depicts a schematic energy diagram of each ion in the ion chain 106 according to one embodiment. In one example, each ion may be a positive Ytterbium ion, ¹⁷¹Yb⁺ which has the ²S_{1/2} hyperfine states (i.e., two electronic states) with an energy split corresponding to a frequency difference (referred to as a “carrier frequency”) of ω₀₁/2π=12.6 GHz. A qubit is formed with the two hyperfine states, used to represent computational basis |0 [symbol] and |1 [symbol] (|i [symbol] (i∈Z)), where the hyperfine ground state (i.e., the lower energy state of the ²S_{1/2} hyperfine states) is chosen to represent |0 [symbol] . Hereinafter, the terms “hyperfine states,” “internal hyperfine states,” and “qubit states” may be interchangeably used to represent computational basis states |0 [symbol] and |1 [symbol] (|i [symbol] (i∈Z)). Each ion may be cooled (i.e., kinetic energy of the ion may be reduced) to near the motional ground state |0 [symbol] ₘ for any motional mode m with no phonon excitation (i.e., nₚₕ=0) by known laser cooling methods, such as Doppler cooling or resolved sideband cooling, and then the qubit state prepared in the hyperfine ground state |0 [symbol] by optical pumping. Here, |0 [symbol] represents the individual qubit state of a trapped ion whereas |0 [symbol] ₘ with the subscript m denotes the motional ground state for a motional mode m of the ion chain 106.

An individual qubit state of each trapped ion may be manipulated by, for example, a mode-locked laser at 355 nanometers (nm) via the excited ²P_{1/2} level (denoted as |e [symbol] ). As shown in FIG. 2A, a laser beam from the laser may be split into a pair of non-copropagating laser beams (a first laser beam with frequency ω₁ and a second laser beam with frequency ω₂) in the Raman configuration, and detuned by a one-photon transition detuning frequency Δ=ω₁−ω₀ₑ with respect to the transition frequency ω₀ₑ between |0 [symbol] and |e [symbol] , as illustrated in FIG. 2A. A two-photon transition detuning frequency δ includes adjusting the amount of energy that is provided to the trapped ion by the first and second laser beams, which when combined is used to cause the trapped ion to transfer between the hyperfine states |0 [symbol] and |1 [symbol] . When the one-photon transition detuning frequency Δ is much larger than a two-photon transition detuning frequency (also referred to simply as “detuning frequency”) δ=ω₁−ω₂−ω₀₁ (hereinafter denoted as ±μ, μ being a positive value), single-photon Rabi frequencies Ω₀ₑ(t) and Ω₁ₑ(t) (which are time-dependent, and are determined by amplitudes and phases of the first and second laser beams), at which Rabi flopping between states |0 [symbol] and |e [symbol] and between states |1 [symbol] and |e [symbol] respectively occur, and a spontaneous emission rate from the excited state |e [symbol] , Rabi flopping between the two hyperfine states |0 [symbol] and |1 [symbol] (referred to as a “carrier transition”) is induced at the two-photon Rabi frequency Ω(t). The two-photon Rabi frequency Ω(t) has an intensity (i.e., absolute value of amplitude) that is proportional to Ω₀ₑΩ₁ₑ/2Δ, where Ω₀ₑ and Ω₁ₑ are the single-photon Rabi frequencies due to the first and second laser beams, respectively. Hereinafter, this set of non-copropagating laser beams in the Raman configuration to manipulate internal hyperfine states of qubits (qubit states) may be referred to as a “composite pulse” or simply as a “pulse,” and the resulting time-dependent pattern of the two-photon Rabi frequency Ω(t) may be referred to as an “amplitude” of a pulse or simply as a “pulse,” which are illustrated and further described below. The detuning frequency δ=ω₁−ω₂−ω₀₁ may be referred to as detuning frequency of the composite pulse or detuning frequency of the pulse. The amplitude of the two-photon Rabi frequency Ω(t), which is determined by amplitudes of the first and second laser beams, may be referred to as an “amplitude” of the composite pulse.

It should be noted that the particular atomic species used in the discussion provided herein is just one example of atomic species which has stable and well-defined two-level energy structures when ionized and an excited state that is optically accessible, and thus is not intended to limit the possible configurations, specifications, or the like of an ion trap quantum computer according to the present disclosure. For example, other ion species include alkaline earth metal ions (Be⁺, Ca⁺, Sr⁺, Mg⁺, and Ba⁺) or transition metal ions (Zn⁺, Hg⁺, Cd⁺).

FIG. 2B depicts a schematic motional sideband spectrum of each ion in the ion chain 106 in a motional mode |nₚₕ [symbol] _{M} having frequency ωₘ according to one embodiment. As illustrated in FIG. 2B, when the detuning frequency of the composite pulse is zero (i.e., a frequency difference between the first and second laser beams is tuned to the carrier frequency, δ=ω₁−ω₂−ω₀₁=0), simple Rabi flopping between the qubit states |0 [symbol] and |1 [symbol] (carrier transition) occurs. When the detuning frequency of the composite pulse is positive (i.e., the frequency difference between the first and second laser beams is tuned higher than the carrier frequency, δ=ω₁−ω₂−ω₀₁=>0, referred to as a blue sideband), Rabi flopping between combined qubit-motional states |0 [symbol] |nₚₕ [symbol] ₘ and |1 [symbol] |nₚₕ+1 [symbol] ₘ occurs (i.e., a transition from the m-th motional mode with n-phonon excitations denoted by |nₚₕ [symbol] ₘ to the m-th motional mode with (nₚₕ+1)-phonon excitations denoted by |nₚₕ+1 [symbol] ₘ occurs when the qubit state |0 [symbol] flips to |1 [symbol] ). When the detuning frequency of the composite pulse is negative (i.e., the frequency difference between the first and second laser beams is tuned lower than the carrier frequency by the frequency ωₘ of the motional mode |nₚₕ)ₘ, δ=ω₁−ω₂−ω₀₁=−μ<0, referred to as a red sideband), Rabi flopping between combined qubit-motional states |0 [symbol] |nₚₕ)ₘ and |1 [symbol] |nₚₕ−1 [symbol] ₘ occurs (i.e., a transition from the motional mode |nₚₕ [symbol] ₘ to the motional mode |nₚₕ−1 [symbol] ₘ with one less phonon excitations occurs when the qubit state |0 [symbol] ₘ flips to |1 [symbol] ). A π/2-pulse on the blue sideband applied to a qubit transforms the combined qubit-motional state |0 [symbol] |nₚₕ)ₘ into a superposition of |0 [symbol] |nₚₕ)ₘ and |1 [symbol] |nₚₕ+1)ₘ. A π/2-pulse on the red sideband applied to a qubit transforms the combined qubit-motional |0 [symbol] |nₚₕ)ₘ into a superposition of |0 [symbol] |nₚₕ)ₘ and |1 [symbol] |nₚₕ−1)ₘ. When the two-photon Rabi frequency Ω(t) is smaller as compared to the detuning frequency δ=ω₁−ω₂−ω₀₁=±μ, the blue sideband transition or the red sideband transition may be selectively driven. Thus, qubit states of a qubit can be entangled with a desired motional mode by applying the right type of pulse, such as a π/2-pulse, which can be subsequently entangled with another qubit, leading to an entanglement between the two qubits that is needed to perform an XX-gate operation in an ion trap quantum computer.

### Hybrid Quantum-Classical Computing System

While currently available quantum computers may be noisy and prone to errors, a combination of both quantum and classical computers, in which a quantum computer is a domain-specific accelerator, may be able to solve optimization problems that are beyond the reach of classical computers. An example of such optimization problems is a search for the lowest energy (or an energy closest to the lowest energy) of a many-particle system by the Variational Quantum Eigensolver (VQE) algorithm by iterating computations between a quantum processor and a classical computer. In such algorithms, a configuration of electrons or spins that is best known approximation calculated by the classical computer is input to the quantum processor as a trial state and the energy of the trial state is estimated using the quantum processor. The classical computer receives this estimate, modifies the trial state by a known classical optimization algorithm, and returns the modified trial state back to the quantum processor. This iteration is repeated until the estimate received from the quantum processor is within a predetermined accuracy.

Another example optimization problem is in solving combinatorial optimization problems, where Quantum Approximate Optimization Algorithm (QAOA) perform search for optimal solutions from a set of possible solutions according to some given criteria, using a quantum computer and a classical computer. The combinatorial optimization problems that can be solved by the methods described herein may include the travelling salesman problem for finding shortest and/or cheapest possible route that visits each city exactly once and returns to a starting city, given a list of cities along with distance or the cost of travel between each pair of cities. The travelling salesman problem is applied to various problems, such as scheduling school buses minimizing the number of routes and total distance while no bus is overloaded or exceeds a maximum allowed policy, scheduling a printing press for a periodical with multi-editions, scheduling a crew of messengers to pick up deposit from branch banks and return the deposit to a central bank, determining an optimal path for each army planner to accomplish the goals of the mission in minimum possible time, designing global navigation satellite system (GNSS) surveying networks, and the like. The combinatorial optimization problems that can be solved by the methods described herein may further include the PageRank (PR) problem for ranking web pages in search engine results and the maximum-cut (MaxCut) problem with applications in clustering, network science, and statistical physics. The MaxCut problem aims at grouping nodes of a graph into two partitions by cutting across links between them in such a way that a weighted sum of intersected edges is maximized. Another combinatorial optimization problem is the knapsack problem to find a way to pack a knapsack to get the maximum total value, given some items. The knapsack problem is applied to resource allocation given financial constraints in home energy management, network selection for mobile nodes, cognitive radio networks, sensor selection in distributed multiple radar, or the like. Other example optimization problems include the stable set problem, the maximum clique problem, and the vertex cover problem.

A combinatorial optimization problem is modeled by an objective function (also referred to as a “cost function”) that maps events or values of one or more variables onto real numbers representing “cost” associated with the events or values and seeks to minimize the cost function. In some cases, the combinatorial optimization problem may seek to maximize the objective function. The combinatorial optimization problem is further mapped onto a simple physical system described by a model Hamiltonian (corresponding to the sum of kinetic energy and potential energy of all particles in the system) and the problem seeks the low-lying energy state of the physical system, as in the case of the Variational Quantum Eigensolver (VQE) algorithm.

This hybrid quantum-classical computing system has at least the following advantages. First, an initial guess is derived from a classical computer, and thus the initial guess does not need to be constructed in a quantum processor that may not be reliable due to inherent and unwanted noise in the system. Second, a quantum processor performs a small-sized (e.g., between a hundred qubits and a few thousand qubits) but accelerated operation (that can be performed using a small number of quantum logic gates) between an input of a guess from the classical computer and a measurement of a resulting state, and thus a NISQ device can execute the operation without accumulating errors. Thus, the hybrid quantum-classical computing system may allow challenging problems to be solved, such as small but challenging combinatorial optimization problems, which are not practically feasible on classical computers, or suggest ways to speed up the computation with respect to the results that would be achieved using the best known classical algorithm.

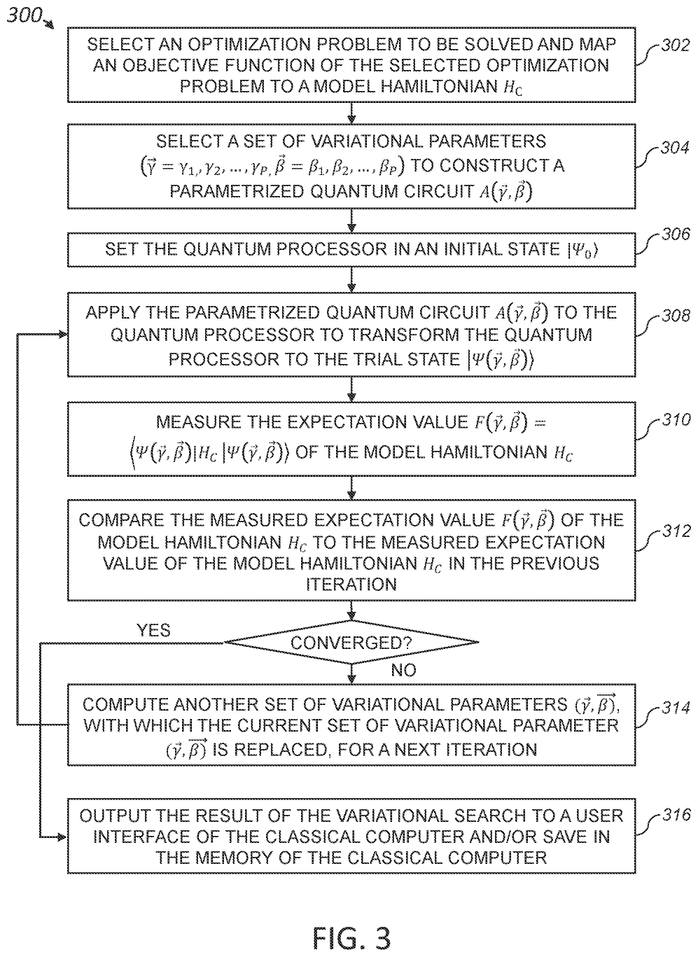

FIG. 3 depicts a flowchart illustrating a method 300 of obtaining a solution to an optimization problem by Quantum Approximate Optimization Algorithm (QAOA) according to one embodiment. In this example, the quantum processor is the ion chain 106 of N trapped ions, in which the two hyperfine states of each of the N trapped ions form a qubit, for example, the hyperfine ground state representing qubit state |0 [symbol] and the hyperfine excited state representing qubit state |1 [symbol] .

The QAOA algorithm relies on a variational search by the well-known Rayleigh-Ritz variational principle. The variational method consists of iterations that include choosing a “trial state” of the quantum processor depending on a set of one or more parameters (referred to as “variational parameters”) and measuring an expectation value of the model Hamiltonian (e.g., energy) of the trial state. A set of variational parameters (and thus a corresponding trial state) is adjusted and an optimal set of variational parameters is found that minimizes the expectation value of the model Hamiltonian (e.g., the energy). The resulting energy approximates the exact lowest energy state of the model Hamiltonian.

The method begins with block 302, in which, by the classical computer 102, an optimization problem to be solved by the QAOA is selected, for example, by use of a user interface of the classical computer 102, or retrieved from the memory of the classical computer 102, and a model Hamiltonian H_{C} is mapped to the selected combinatorial optimization problem. In the example described herein, the traveling salesman problem (TSP) is selected as an optimization problem to be solved, and a model Hamiltonian H_{C} of one-dimensional (1D) Hubbard model (referred to as a “Hubbard Hamiltonian”) is selected to map to an objective function of the TSP.

The travelling salesman problem (TSP) can be modelled using an undirected weighted graph such that a vertex i represents a city i (i=1, 2, . . . , n), an edge xᵢⱼ represents a path between cities i and j, and a weight wᵢⱼ of the edge xᵢⱼ represents a cost of travel between cities i and j. The edge xᵢⱼ takes 1 if the path goes from city i to city j, and 0 otherwise. The objective in the problem is to find a tour of all n cities, starting and ending at one city with the cheapest travel cost. That is, the goal is to minimize the total travel cost of the tour:

$${\sum }_{i = 1}^{n} {\sum }_{j \neq i , j = 1}^{n} {w}_{ij} {x}_{ij}$$

under certain edge constraints. Local edge constrains at each city i are that there is exactly one edge coming into city i:

$${\sum }_{j \neq i , j = 1}^{n} {x}_{ij} = 1 ( i = 1 , 2 , ... , n )$$

and exactly one edge coming out of city i:

$${\sum }_{j \neq i , j = 1}^{n} {x}_{ij} = 1 ( i = 1 , 2 , ... , n ) .$$

The objective function C to minimize is:

$$C = {\sum }_{i = 1}^{n} {\sum }_{j \neq i , j = 1}^{n} {w}_{ij} {x}_{ij} + A {\sum }_{i = 1}^{n} {( {\sum }_{j \neq i , j = 1}^{n} {x}_{ji} - 1 )}^{2} + A {\sum }_{i = 1}^{n} {( {\sum }_{j \neq i , j = 1}^{n} {x}_{ij} - 1 )}^{2}$$

with a penalty function (the last two terms), where A is a large parameter (A>max (wᵢⱼ)^{∀}i,j) that represents a measure of violation of the local edge constraints. The measure of violation is nonzero (A) when the local edge constraints are violated and is zero when the local edge constraints are not violated. The TSP is now a problem of finding a solution to minimize the objective function C with the local constraints that the number of selected edges xᵢⱼ is equal to the number n of vertices i. In addition to the local edge constraints, subtour (that does not visit all n cities) elimination constraints are added. That is, a tour cannot be divided into multiple subtours. A subtour elimination constraint is added during the computation of the expectation value on the classical computer in block 310. This constraint penalizes the expectation value of a trial state if the trial state produces more than one tour which does not include all vertices i even if the total number of selected edges xᵢⱼ is maintained at the number n of vertices i.

Minimizing the objective function C can be converted to finding a low-lying energy state of a model Hamiltonian H_{C}

$${H}_{C} = {\sum }_{k = 1}^{n} {ε}_{k} {n}_{k} + t {c}_{k}^{†} {c}_{l} + U {n}_{k} {n}_{l}$$

of a 1 D Hubbard model that describes particles each having one electron bounded on a 1D array of sites k=1, 2, . . . , N. Here, the site N is next to site 1. The number of sites N equals the total number of edges xᵢⱼ. The first term describes a sum of on-site potentials εₖ. The second term describes kinetic energy by hopping (tunneling) t of particles between two sites [symbol] k, l [symbol] . The third term describes Coulomb repulsion U between two sites [symbol] k,l [symbol] . Here nₖ is the number operator, an expectation value of which describes the number of electrons on site k, and cₖ^{\} and cₗ are the creation and annihilation operators that creates and annihilates an electron on site k.

In mapping the TSP to the 1D Hubbard model, the edge xᵢⱼ and its weight cᵢⱼ in the objective function C are mapped to the number operator nₖ and the on-site potential εₖ in the 1D Hubbard model, respectively. The local edge constraints are mapped to the Coulomb terms, where the Coulomb repulsion U between sites that correspond to the edges xⱼᵢ and x_{j,i} and sites that correspond to the edges xᵢⱼ and xᵢⱼ, are non-zero. A value of the Coulomb repulsion U is chosen to be larger than the on-site potential εₖ (U>max(εₖ)^{∀}k). A condition that the number of electrons (referred to as “Hamming weight”) is constant at the number of selected edges xᵢⱼ that are 1's (i.e., the number n of vertices i) is also imposed to ensure that the number of electrons is exactly the number of selected edges xᵢⱼ to make a complete tour.

The quantum processor 106 has N qubits and each number operator nₖ (k=1, 2, . . . , N) is encoded in qubit k (k=1, 2, . . . , N) in the quantum processor 106. For example, the states where the number operator nₖ is 0 and 1 are encoded as |0 [symbol] and |1 [symbol] of the qubit k, respectively.

In block 304, a set of variational parameters (\vec{γ}=γ₁, γ₂, . . . , γ_{P}, \vec{β}=β₁, β₂, β_{P}) is selected, by the classical computer 102, to construct a sequence of gates (also referred to a “parametrized quantum circuit”) A(\vec{γ},\vec{β}), which prepares the quantum processor 106 in a trial state |Ψ(\vec{γ},\vec{β}) [symbol] . For the initial iteration, a set of variational parameters (\vec{γ},\vec{β}) may be randomly chosen for the initial iteration. In the example where the initial state is a non-uniform superposition of all possible state of a given Hamming weight (shown below), the set of variational parameters (\vec{γ}, \vec{β}) is chosen such that a state in which n qubits in the |1 [symbol] state are clustered together (e.g., |000011111 [symbol] for 5 vertices and 9 edges) is transformed to a superposition of states each having n qubits in the |1 [symbol] state, where n is the number of vertices i, as given by the Givens decomposition method known in the art. The output of the Givens decomposition method are the angles for the gates that need to be applied to the initial state (e.g., |000011111 [symbol] ) in the quantum circuit that would yield the superposition of states each having n qubits in the |1 [symbol] state. The angles for the gates which are the output of the Givens decomposition are used as the set of variational parameters (\vec{γ}, \vec{β}).

This trial state |Ψ(\vec{γ},\vec{β}) [symbol] is used to provide an expectation value of the model Hamiltonian H_{C}.

The parametrized quantum circuit A(\vec{γ}, \vec{β}) includes P layers (i.e., P-time repetitions) of an entangling circuit U(γₚ) that relates to the model Hamiltonian H_{C} (U(γₚ)=e^{-iγ}^{ₚ}^{H}^{_{C}}) and a mixing circuit U_{Mix}(βₚ) that relates to a mixing term

$${H}_{B} = {\sum }_{〈 k , l 〉 n . n .} ( {σ}_{k}^{X} {σ}_{l}^{X} + {σ}_{k}^{Y} {σ}_{l}^{Y} )$$

(U_{Mix}(β_{P})=e^{-iβ}^{ₚ}^{H}^{_{B}}) (p=1, 2, . . . , P) as

$$A ( \vec{γ} , \vec{β} ) = {U}_{Mix} ( {β}_{P} ) {U}_{Mix} ( {β}_{P - 1} ) U ( {γ}_{P - 1} ) ... {U}_{Mix} ( {β}_{1} ) U ( {γ}_{1} ) ,$$

where σₖ^{X}, σₖ^{Y}, or σₖ^{z} are the Pauli matrices on qubit k. Each term σₖ^{X}σₗ^{X}+σₖ^{Y} σₗ^{Y} in the mixing term H_{B} generates a parametrized Givens rotation gate applied to qubits k and l:

$$G ( {β}_{p} ) = ( \begin{matrix}1 & 0 & 0 & 0 \\ 0 & cos ( {β}_{p} ) & - sin ( {β}_{p} ) & 0 \\ 0 & sin ( {β}_{p} ) & cos ( {β}_{p} ) & 0 \\ 0 & 0 & 0 & 1\end{matrix} )$$

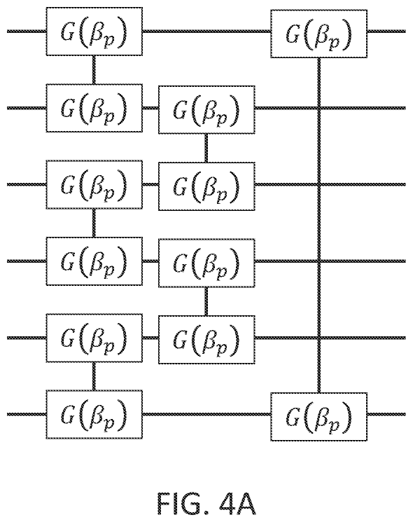

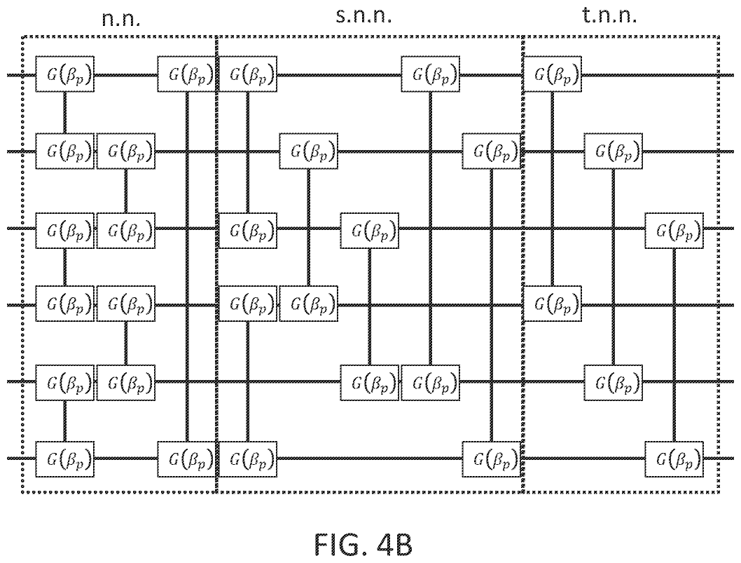

in the quantum processor 106. In the mixing circuit U_{Mix}(βₚ), Givens Rotation gates G(βₚ) are applied to pairs of nearest neighbor (n.n.) qubits [symbol] k,l [symbol] . FIG. 4A depicts an example of the mixing circuit U_{Mix} (βₚ) for six qubits. It should be noted that a Givens rotation gate G(βₚ) maintains the Hamming weight of the qubit state when applied. In some embodiments, a mixing term

$${H}_{B} = {\sum }_{〈 k , l 〉} ( {σ}_{k}^{X} {σ}_{l}^{Y} - {σ}_{k}^{Y} {σ}_{l}^{X} )$$

is used.

In block 306, the quantum processor 106 is set in an initial state |Ψ₀ [symbol] by the system controller 104. In the variational method, iterative convergence relates to the number of iterations required to obtain residuals that are sufficiently close to zero, and depends on the initial state |Ψ₀ [symbol] of the iterations. If the initial state |Ψ₀ [symbol] is in a superposition of states, one of which corresponds to the ground state of the model Hamiltonian H_{C}, the ground state can likely be reached by the iteration. In the embodiments described herein, the initial state |Ψ₀ [symbol] is prepared in one of the following three states.

I. Superposition of states with large spread of the |1 [symbol] states: The initial state |Ψ₀ [symbol] may be prepared by setting the quantum processor 106 in a state where n qubits in the |1 [symbol] state are spread over the quantum processor 106, for example, |01010101 [symbol] , and then applying one layer of Givens rotation gates

$$G ( {β}_{p} ) = ( \begin{matrix}1 & 0 & 0 & 0 \\ 0 & cos ( {β}_{p} ) & - sin ( {β}_{p} ) & 0 \\ 0 & sin ( {β}_{p} ) & cos ( {β}_{p} ) & 0 \\ 0 & 0 & 0 & 1\end{matrix} )$$

on all pairs of nearest neighbor (n.n.) qubits [symbol] k, k+1) (k=1, 2, . . . , N, qubit N+1 corresponds to qubit 1). The state where n qubits in the |1 [symbol] state are spread can be prepared by application of a proper combination of single-qubit operations and two-qubit operations to all qubits set in the hyperfine ground state |0 [symbol] . A qubit can be set in the hyperfine ground state |0 [symbol] by optical pumping. A layer of Givens rotation gates may be further applied to pairs of second nearest neighbor (s.n.n.) qubits [symbol] k, k+2 [symbol] (k=1, 2, . . . , N, qubit N+2 corresponds to qubit 2) and to pairs of third nearest neighbor (t.n.n.) qubits [symbol] k, k+3) (k=1, 2, . . . , N, qubit N+3, corresponds to qubit 3) to prepare initial state |Ψ₀ [symbol] . FIG. 4B depicts an example of the Givens rotation gates applied to six qubits.

II. Non-uniform superposition of all possible states of a given Hamming weight: The initial state |Ψ₀ [symbol] may be prepared in a non-uniform superposition of all states of a given Hamming weight (e.g., n) using the Givens decomposition method known in the art. The initial state |Ψ₀ [symbol] may be a state having n qubits in the |1 [symbol] state (where n is the number of vertices i). All the qubits in the |1 [symbol] state can be clustered together, e.g., |000011111 [symbol] for 5 vertices and 9 edges.

III. Uniform superposition of all possible states of a given Hamming weight (referred to as a “Dicke” state): It has been known that the Dicke state is guaranteed to contain the ground state of the model Hamiltonian H_{C}. The Dicke state can be prepared by applying O(kN) CNOT gates to the quantum processor 106 in a state where n qubits are in in the |1 [symbol] state.

In block 308, the parametrized quantum circuit A(\vec{γ}, \vec{β}) is applied to the quantum processor 106, by the system controller 104, to transform the quantum processor 106 to the trial state |Ψ(\vec{γ}, \vec{β}) [symbol] for evaluating an expectation of the model Hamiltonian H_{C}.

In block 310, the expectation value F(\vec{γ}, \vec{β})= [symbol] Ψ(\vec{γ}, \vec{β})|H_{C}|Ψ(\vec{γ}, \vec{β})) of the model Hamiltonian H_{C} is measured by the system controller 104. Repeated measurements of populations of the trapped ions in the ion chain 106 in the trial state |Ψ(\vec{γ}, \vec{β}) [symbol] (by collecting fluorescence from each trapped ion and mapping onto the PMT 110) yield the expectation value the model Hamiltonian H_{C}. A subtour elimination constraint is added to penalize the expectation value F(\vec{γ}, \vec{β}) of a trial state |Ψ(\vec{γ}, \vec{β}) [symbol] if the trial state |Ψ(\vec{γ}, \vec{β}) [symbol] produces more than one tour which does not include all vertices i.

In block 312, the measured expectation value F(\vec{γ}, \vec{β}) of the model Hamiltonian H_{C} is compared to the measured expectation value of the model Hamiltonian H_{C} in the previous iteration, by the classical computer 102. If a difference between the two values (referred to as a residual) is less than a predetermined value (i.e., the expectation value sufficiently converges towards a fixed value), the method proceeds to block 316. If the difference between the two values is more than the predetermined value, the method proceeds to block 314.

In block 314, another set of variational parameters (\vec{γ}, \vec{β}), with which the current set of variational parameter (\vec{γ}, \vec{β}) is replaced, for a next iteration of blocks 308 to 312 is computed by the classical computer 102, in search for an optimal set of variational parameters (\vec{γ}, \vec{β}) to minimize the expectation value of the model Hamiltonian H_{C}, F(\vec{γ}, \vec{β})= [symbol] Ψ(\vec{γ}, \vec{β})|H_{C}|Ψ(\vec{γ}, \vec{β}) [symbol] . That is, the classical computer 102 executes a classical optimization method to find the optimal set of variational parameters

$$( \vec{γ} , \vec{β} ) ( {min}_{\vec{γ} , \vec{β}} F ( \vec{γ} , \vec{β} ) ) .$$

Examples of conventional classical optimization methods include simultaneous perturbation stochastic approximation (SPSA), particle swarm optimization (PSO), Bayesian optimization (BO), and Nelder-Mead (NM).

In block 316, the result of the variational search is outputted, by the classical computer 102, to a user interface of the classical computer 102 and/or saved in the memory of the classical computer 102. The final results of the variational search includes the measured expectation value of the model Hamiltonian H_{C} in the final iteration corresponding to the minimized value of the objective function C(e.g., the cheapest travel cost of a tour) and the measurement of the trail state |Ψ(\vec{γ}, \vec{β}) [symbol] in the final iteration corresponding to the tour providing the cheapest travel cost.

The method for obtaining a solution to the travelling salesman problem on a hybrid quantum-classical computing system described herein uses mapping onto a one-dimensional (1D) Hubbard model. Edges of a weighted graph describing the travelling saleman problem are treated as sited in the Hubbard model. The Coulomb repulsion terms are used as a penalty for the local edge constraints. In the variational search, a mixing term including Givens rotation gates that concerves the Hamming weight. The variational search starts with an initial state that spans a large portion of the solution space, leading to convergence of the variational search.

While the foregoing is directed to specific embodiments, other and further embodiments may be devised without departing from the basic scope thereof, and the scope thereof is determined by the claims that follow.

1. A method of performing computation in a hybrid quantum-classical computing system comprising a classical computer and a quantum processor, comprising:
mapping, by a classical computer, an objective function of an optimization problem to a model Hamiltonian;
selecting, by the classical computer, a set of variational parameters to construct a parametrized quantum circuit comprising an entangling circuit based on the model Hamiltonian and a mixing circuit;
setting, by a system controller, a quantum processor in an initial state, wherein the quantum processor comprises a plurality of trapped ions, each of which has two hyperfine states defining a qubit;
executing iterations, each iteration comprising:
applying, by the system controller, the parametrized quantum circuit to the quantum processor based on the set of the variational parameters and the model Hamiltonian, to transform the quantum processor to a trial state;
measuring, by the system controller, an expectation value of the model Hamiltonian; and
replacing, by the classical computer, the set of the variational parameters with another set of variational parameters, if a difference between the measured expectation value of the model Hamiltonian and the expectation value of the model Hamiltonian measured in the previous iteration is more than a predetermined value; and
outputting the set of the variational parameters,
wherein the initial state and the trial state each are a superposition of states where the number of trapped ions of the plurality of trapped ions in the hyperfine excited state is constant, and
the mixing circuit maintains the number of the trapped ions in the hyperfine excited state.

2. The method of claim 1, wherein
the optimization problem is the travelling salesman problem, and
the model Hamiltonian is a Hubbard Hamiltonian.

3. The method of claim 1, wherein the initial state is a superposition of states where the trapped ions in the hyperfine ground state are spread over the quantum processor.

4. The method of claim 1, wherein the initial state is a non-uniform superposition of all possible states where the number of trapped ions of the plurality of trapped ions in the hyperfine excited state is constant.

5. The method of claim 1, wherein the initial state is a uniform superposition of all possible states where the number of trapped ions of the plurality of trapped ions in the hyperfine excited state is constant.

6. The method of claim 1, wherein the set of the variational parameters is initially selected randomly.

7. A hybrid quantum-classical computing system, comprising:
a quantum processor comprising a plurality of trapped ions, each of the trapped ions having two hyperfine states defining a qubit;
one or more lasers configured to emit a laser beam, which is provided to trapped ions in the quantum processor; and
a classical computer configured to:
map an objective function of an optimization problem to a model Hamiltonian;
select a set of variational parameters to construct a parametrized quantum circuit comprising an entangling circuit based on the model Hamiltonian and a mixing circuit;
control a system controller to the quantum processor in an initial state;
execute iterations, each iteration comprising:
controlling the system controller to apply the parametrized quantum circuit to the quantum processor based on the set of the variational parameters and the model Hamiltonian, to transform the quantum processor to a trial state;
controlling by the system controller to measure an expectation value of the model Hamiltonian; and
replacing the set of the variational parameters with another set of variational parameters, if a difference between the measured expectation value of the model Hamiltonian and the expectation value of the model Hamiltonian measured in the previous iteration is more than a predetermined value; and
output the set of the variational parameters,
wherein the initial state and the trial state each are a superposition of states where the number of trapped ions of the plurality of trapped ions in the hyperfine excited state is constant, and
the mixing circuit maintains the number of the trapped ions in the hyperfine excited state.

8. The hybrid quantum-classical computing system of claim 7, wherein
each of the trapped ions is ¹⁷¹Yb⁺ having the ²S_{1/2} hyperfine states.

9. The hybrid quantum-classical computing system of claim 7, wherein
each of the trapped ions is one selected from Be⁺, Ca⁺, Sr⁺, Mg⁺, Ba⁺, Zn⁺, Hg⁺, Cd⁺.

10. The hybrid quantum-classical computing system of claim 7, wherein
the optimization problem is the travelling salesman problem, and
the model Hamiltonian is a Hubbard Hamiltonian.

11. The hybrid quantum-classical computing system of claim 7, wherein the initial state is a superposition of states where the trapped ions in the hyperfine ground state are spread over the quantum processor.

12. The hybrid quantum-classical computing system of claim 7, wherein the initial state is a non-uniform superposition of all possible states where the number of trapped ions of the plurality of trapped ions in the hyperfine excited state is constant.

13. The hybrid quantum-classical computing system of claim 7, wherein the initial state is a uniform superposition of all possible states where the number of trapped ions of the plurality of trapped ions in the hyperfine excited state is constant.

14. The hybrid quantum-classical computing system of claim 7, wherein the set of the variational parameters is initially selected randomly.

15. A hybrid quantum-classical computing system comprising non-volatile memory having a number of instructions stored therein which, when executed by one or more processors, causes the hybrid quantum-classical computing system to perform operations comprising:
mapping, by a classical computer, an objective function of an optimization problem to a model Hamiltonian;
selecting, by the classical computer, a set of variational parameters to construct a parametrized quantum circuit comprising an entangling circuit based on the model Hamiltonian and a mixing circuit;
setting, by a system controller, a quantum processor in an initial state, wherein the quantum processor comprises a plurality of trapped ions, each of which has two hyperfine states defining a qubit;
executing iterations, each iteration comprising:
applying, by the system controller, the parametrized quantum circuit to the quantum processor based on the set of the variational parameters and the model Hamiltonian, to transform the quantum processor to a trial state;
measuring, by the system controller, an expectation value of the model Hamiltonian; and
replacing, by the classical computer, the set of the variational parameters with another set of variational parameters, if a difference between the measured expectation value of the model Hamiltonian and the expectation value of the model Hamiltonian measured in the previous iteration is more than a predetermined value; and
outputting the set of the variational parameters,
wherein the initial state and the trial state each are a superposition of states where the number of trapped ions of the plurality of trapped ions in the hyperfine excited state is constant, and
the mixing circuit maintains the number of the trapped ions in the hyperfine excited state.

16. The hybrid quantum-classical computing system of claim 15, wherein
the optimization problem is the travelling salesman problem, and
the model Hamiltonian is a Hubbard Hamiltonian.

17. The hybrid quantum-classical computing system of claim 15, wherein the initial state is a superposition of states where the trapped ions in the hyperfine ground state are spread over the quantum processor.

18. The hybrid quantum-classical computing system of claim 15, wherein the initial state is a non-uniform superposition of all possible states where the number of trapped ions of the plurality of trapped ions in the hyperfine excited state is constant.

19. The hybrid quantum-classical computing system of claim 15, wherein the initial state is a uniform superposition of all possible states where the number of trapped ions of the plurality of trapped ions in the hyperfine excited state is constant.

20. The hybrid quantum-classical computing system of claim 15, wherein the set of the variational parameters is initially selected randomly.
